(19) United States
(12) Patent Application Publication
(10) Pub. No.: US 2026/0074601 A1
(43) Pub. Date: Mar. 12, 2026

(54) POWER SUPPLY CONVERSION DEVICE

(71) Applicant: Montage Technology (Kunshan) Co., Ltd., Suzhou (CN)

(72) Inventors: Zongjie Hu, Shanghai (CN); Xuexin Ding, Shanghai (CN)

(73) Assignee: Montage Technology (Kunshan) Co., Ltd., Suzhou (CN)

(21) Appl. No.: 19/302,050

(22) Filed: Aug. 17, 2025

(30) Foreign Application Priority Data
Sep. 6, 2024 (CN) 202411251972.8

(51) Int. Cl. H02M 1/00; H02M 3/156

(52) U.S. Cl. CPC H02M 1/0003; H02M 3/156

(57) ABSTRACT

A power supply conversion device includes a voltage converter, a turned-off time detector, a turned-on time adjuster, and a slope signal adjuster. The voltage converter receiving an input voltage converts the input voltage according to a control signal to generate an output voltage. The turned-off time detector coupled to the voltage converter generates detection information by detecting a time length of the control signal in turned-off state. The turned-on time adjuster adjusts a time length of the control signal in turned-on state according to the detection information. The slope signal adjuster adjusts a rising rate of a switching signal on a switch of the voltage converter according to the detection information to generate a slope signal, generates a feedback signal according to the slope signal, and provides the feedback signal to the voltage converter.

### CROSS-REFERENCE TO RELATED APPLICATION

This application claims the priority benefit of China application serial no. 202411251972.8, filed on Sep. 6, 2024. The entirety of the above-mentioned patent application is hereby incorporated by reference herein and made a part of this specification.

### BACKGROUND

### Technical Field

The disclosure relates to a power supply conversion device, and in particular to a power supply conversion device which may quickly respond to load changes.

### Description of Related Art

With the advancement of electronic technology, in order to meet power supply requirements of electronic devices, power supply conversion devices have become an important part of the electronic devices. In current applications, the power supply conversion devices need to control the voltage conversion mechanism according to rapid load changes, so that the output voltage matches the load changes. However, when the load changes rapidly from light to heavy or from heavy to light, in order to respond quickly to the load changes, existing power supply conversion devices often encounter two situations when controlling the voltage conversion mechanism to quickly adjust the output voltage. One situation is that the response is not fast enough, causing the output voltage to drop too much. The other situation is that the response is too fast, causing additional overshoot in the output voltage. Therefore, how to balance the response speed of the power supply conversion devices and the quality of the output voltage is an important issue for persons skilled in the art.

### SUMMARY

The disclosure provides a power supply conversion device, which has a fast reaction rate to load changes.

According to an embodiment of the disclosure, a power supply conversion device includes a voltage converter, a turned-off time detector, a turned-on time adjuster, and a slope signal adjuster. The voltage converter receives an input voltage and converts the input voltage according to a control signal to generate an output voltage. The turned-off time detector is coupled to the voltage converter, and detects a time length of the control signal in a turned-off state to generate detection information. The turned-on time adjuster is coupled to the turned-off time detector and the voltage converter, and adjusts a time length of the control signal in a turned-on state according to the detection information. The slope signal adjuster is coupled to the turned-off time detector and the voltage converter, adjusts the rise rate of the switching signal on the switch of the voltage converter according to the detection information to generate a slope signal, and generates a feedback signal according to the slope signal, and provides the feedback signal to the voltage converter.

### BRIEF DESCRIPTION OF THE DRAWINGS

FIG. 1 shows a schematic diagram of a power supply conversion device according to an embodiment of the disclosure.

FIG. 2 shows a circuit schematic diagram of a turned-off time detector of a power supply conversion device according to an embodiment of the disclosure.

FIG. 3 shows a circuit schematic diagram of a turned-on time adjuster of a power supply conversion device according to an embodiment of the disclosure.

FIG. 4 shows a circuit schematic diagram of a slope signal adjuster of a power supply conversion device according to an embodiment of the disclosure.

FIG. 5 shows a circuit schematic diagram of a minimum turned-off time counter of a power supply conversion device according to an embodiment of the disclosure.

FIG. 6 shows a circuit schematic diagram of a voltage converter of a power supply conversion device according to an embodiment of the disclosure.

FIG. 7A and FIG. 7B respectively show timing diagrams of a power supply conversion device of an embodiment of the disclosure.

### DESCRIPTION OF THE EMBODIMENTS

The following specific examples illustrate the implementation manners of the disclosure. Those skilled in the art may easily understand other advantages and effects of the disclosure from the content disclosed in this specification. The disclosure may also be implemented or applied through other specific embodiments, and various details in this specification may also be modified or changed based on different perspectives and applications, without departing from the spirit of the disclosure. It should be noted that, in the absence of conflict, the features in the following embodiments and embodiments may be combined with each other.

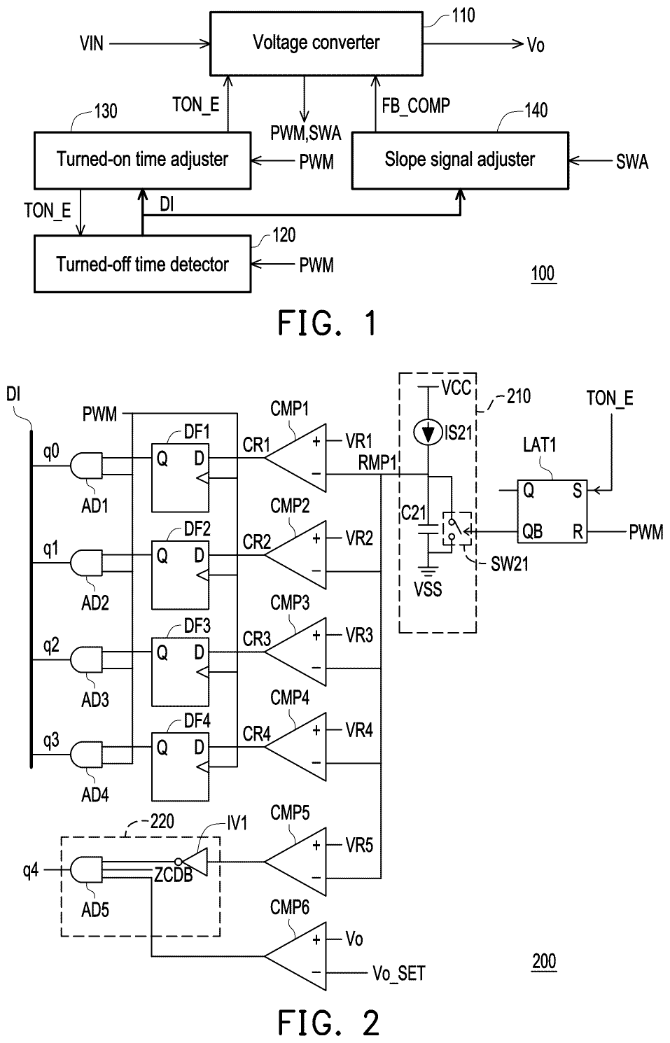

Refer to FIG. 1, FIG. 1 shows a schematic diagram of a power supply conversion device according to an embodiment of the disclosure. A power supply conversion device 100 includes a voltage converter 110, a turned-off time detector 120, a turned-on time adjuster 130, and a slope signal adjuster 140. The voltage converter 110 receives an input voltage VIN, and converts the input voltage VIN according to a control signal PWM to generate an output voltage Vo. In this embodiment, the voltage converter 110 may be any type of DC-to-DC voltage converter, such as a DC-DC voltage buck converter. The control signal PWM may be generated by an internal circuit of the voltage converter 110, which may be a pulse width modulation signal and switch between a high voltage value and a low voltage value. A state when the control signal PWM is at the high voltage value may be called a turned-on state. A state when the control signal PWM is at the low voltage value may be called a turned-off state. In the following embodiments, the time length of the turned-on state is a time length that the control signal PWM maintains at the high voltage value each time, and the time length of the turned-off state is the time length that the control signal PWM maintains at the low voltage value each time.

The turned-off time detector 120 is coupled to the voltage converter 110. The turned-off time detector 120 receives the control signal PWM, and is configured to detect the time length of the control signal PWM being in the turned-off state, and generates detection information DI according to a detection result. The turned-on time adjuster 130 is coupled to the turned-off time detector 120 and the voltage converter 110. The turned-on time adjuster 130 receives the detection information DI and the control signal PWM, and adjusts the time length of the control signal PWM being in the turned-on state according to the detection information DI. Specifically, when the detection information DI indicates that the time length of the control signal PWM being in the turned-off state decreases, the turned-on time adjuster 130 may increase the time length of the control signal PWM being in the turned-on state according to the detection information DI. Conversely, when the detection information DI indicates that the time length of the control signal PWM being in the turned-off state increases, the turned-on time adjuster 130 may decrease the time length of the control signal PWM being in the turned-on state according to the detection information DI. In this embodiment, the turned-on time adjuster 130 may generate a turned-on time termination signal TON_E as a basis for adjusting a termination time point of the control signal PWM being in the turned-on state. The turned-on time adjuster 130 may transmit the turned-on time termination signal TON_E to the turned-off time detector 120 and the voltage converter 110. The voltage converter 110 may reset the state of the control signal PWM to the turned-off state according to the turned-on time termination signal TON_E.

In the operation of the power supply conversion device 100, when a load of the power supply conversion device 100 increases, the control signal PWM may correspondingly decrease the time length of the control signal PWM being in the turned-off state in response to the load increase. In this embodiment, the time adjuster 130 may obtain a state of decreasing the time length of the control signal PWM being in the turned-off state according to the detection information DI, thereby increasing the time length of the control signal PWM being in the turned-on state, to enhance the output power of the power supply conversion device 100, in order to quickly respond to the load increase of the power supply conversion device 100. Correspondingly, when the load of the power supply conversion device 100 decreases, the control signal PWM may correspondingly increase the time length of the control signal PWM being in the turned-off state in response to the load decrease. In this embodiment, the time adjuster 130 may obtain a state that the time length of the control signal PWM being in the turned-off state increases according to the detection information DI, thereby decreasing the time length of the control signal PWM being in the turned-on state, to reduce the output power of the power supply conversion device 100, in order to prevent an overshoot phenomenon of the output voltage Vo caused by the load decrease of the power supply conversion device 100.

The slope signal adjuster 140 is coupled to the turned-off time detector 120 and the voltage converter 110. The slope signal adjuster 140 is configured to receive a switching signal SWA on a switching switch of the voltage converter 110 and the detection information DI output by the turned-off time detector 120. The slope signal adjuster 140 adjusts a rising rate of the switching signal SWA according to the detection information DI to generate a slope signal, and generates a feedback signal FB_COMP according to the generated slope signal. In this embodiment, the slope signal adjuster 140 may provide the feedback signal FB_COMP to the voltage converter 110. The voltage converter 110 may then adjust the time point of the control signal PWM being in the turned-on state according to the feedback signal FB_COMP.

Notably, when the time length of the control signal PWM being in the turned-on state increases, the slope signal adjuster 140 may generate the slope signal by reducing the rising rate of the switching signal SWA according to the detection information DI. Specifically, the slope signal adjuster 140 reduces the rising rate of the switching signal SWA to maintain a peak value of the slope signal substantially at a fixed value. When the time length of the control signal PWM being in the turned-on state decreases, the slope signal adjuster 140 may generate the slope signal by increasing the rising rate of the switching signal SWA according to the detection information DI. Similarly, the slope signal adjuster 140 increases the rising rate of the switching signal SWA to maintain the peak value of the slope signal substantially at the same fixed value.

That is, when the time length of the control signal PWM being in the turned-on state is dynamically adjusted, the slope signal adjuster 140 may maintain the peak value of the slope signal at the same fixed value. This method may keep the loop response rate unchanged. Specifically, if the time length of the control signal PWM being in the turned-on state increases, under the condition that a capacitance value of the slope signal adjuster 140 remains unchanged, the peak value of the slope signal may increase. The increased slope signal may deteriorate the transient response. Therefore, by correcting the capacitance value of the slope signal adjuster 140 to keep the peak value of the slope signal unchanged, the transient response of the loop may be maintained unchanged. Increasing the time length of the control signal PWM being in the turned-on state may make the transient response faster.

Referring to FIG. 2 below, FIG. 2 shows a circuit schematic diagram of a turned-off time detector of a power supply conversion device according to an embodiment of the disclosure. A turned-off time detector 200 includes a slope signal generator 210, comparators CMP1 to CMP6, flip-flops DF1 to DF4, AND gates AD1 to AD4, and a logic circuit 220. The slope signal generator 210 is coupled to a latch LAT1. A set terminal S of the latch LAT1 receives the turned-on time termination signal TON_E. A reset terminal R of the latch LAT1 receives the control signal PWM. An output terminal Q of the latch LAT1 may be floating. An inverted output terminal QB of the latch LAT1 is coupled to the slope signal generator 210. The signal from the inverted output terminal QB of the latch LAT1 is configured to reflect the time length of the control signal PWM being in the turned-off state.

The slope signal generator 210 includes a current source IS21, a capacitor C21, and a switch SW21. The capacitor C21 is connected in parallel with the switch SW21. The current source IS21 is connected in series with a parallel circuit formed by the capacitor C21 and the switch SW21 between a power supply voltage terminal VCC and a reference ground terminal VSS. The switch SW21 is controlled by the signal from the inverted output terminal QB of the latch LAT1. When the switch SW21 is turned on, the slope signal generator 210 resets a generated slope signal RMP1 to a reference ground voltage. When the switch SW21 is turned off, the capacitor C21 is charged according to the current provided by the current source IS21, and generates a rising slope signal RMP1. A peak value of the voltage of the slope signal RMP1 may be associated with the time during which the switch SW21 is cut off, and also with the time length of the control signal PWM being in turned-off state.

Positive input terminals of the comparators CMP1 to CMP4 respectively receive different reference voltages VR1 to VR4. Negative input terminals of the comparators CMP1 to CMP4 commonly receive the slope signal RMP1. The comparators CMP1 to CMP4 are configured to compare the slope signal RMP1 with the reference voltages VR1 to VR4. The reference voltages VR1 to VR4 are arranged in ascending order. The comparators CMP1 to CMP4 may generate multiple comparison results CR1 to CR4 to reflect a voltage level of the slope signal RMP1. Data terminals D of the flip-flops DF1 to DF4 respectively receive the comparison results CR1 to CR4, and latches the comparison results CR1 to CR4 respectively by using the control signal PWM as a clock signal, to generate multiple bits q0 to q3 of the detection information DI. In this embodiment, output terminals Q of the flip-flops DF1 to DF4 do not directly generate the bits q0 to q3 of the detection information DI. The output terminals Q of the flip-flops DF1 to DF4 are respectively coupled to the AND gates AD1 to AD4. The AND gates AD1 to AD4 respectively perform a logical AND operation on the signals from the output terminals Q of the flip-flops DF1 to DF4 with the control signal PWM, to generate the bits q0 to q3 of the detection information DI. In this embodiment, when the time length of the control signal PWM being in the turned-off state is longer, the logic value of the detection information DI is higher.

In addition, a positive input terminal of the comparator CMP5 receives a reference voltage VR5. A negative input terminal of the comparator CMP5 receives the slope signal RMP1. The reference voltage VR5 is greater than the reference voltage VR4. A positive input terminal of the comparator CMP6 receives the output voltage Vo. A negative input terminal of the comparator CMP6 receives a set voltage Vo_SET. The comparators CMP5 and CMP6 are configured to determine whether the overshoot phenomenon has occurred in the output voltage Vo of the power supply conversion device. When the voltage value of the slope signal RMP1 is greater than the reference voltage VR5, and the output voltage Vo is greater than the set voltage Vo_SET, it indicates that the output voltage Vo of the power supply conversion device may experience the overshoot phenomenon.

The logic circuit 220 includes an AND gate AD5 and an inverter IV1. The inverter IV1 is coupled to an output terminal of the comparator CMP5. Multiple input terminals of the AND gate AD5 respectively receive an output signal of the inverter IV1, an output signal of the comparator CMP6, and a zero-crossing detection signal ZCDB, and generate an overshoot improvement signal q4. In this embodiment, when a logic value of the overshoot improvement signal q4 is 1, it indicates that the output voltage Vo of the power supply conversion device has the overshoot phenomenon. Conversely, when the logic value of the overshoot improvement signal q4 is 0, it indicates that the output voltage Vo of the power supply conversion device does not have the overshoot phenomenon.

The overshoot improvement signal q4 may be transmitted to the voltage converter, so that the voltage converter adjusts the turned-on state and turned-off state of the control signal PWM according to the overshoot improvement signal q4.

In this embodiment, the number of comparators CMP1 to CMP4 may be correspondingly adjusted according to the number of bits of the detection information DI to be generated. The number of bits of the detection information DI may be determined by the designer according to the detection precision of the turned-off time to be judged. This embodiment is described with the detection information DI including four bits q0 to q3 as an example, and the disclosure is not limited to thereto.

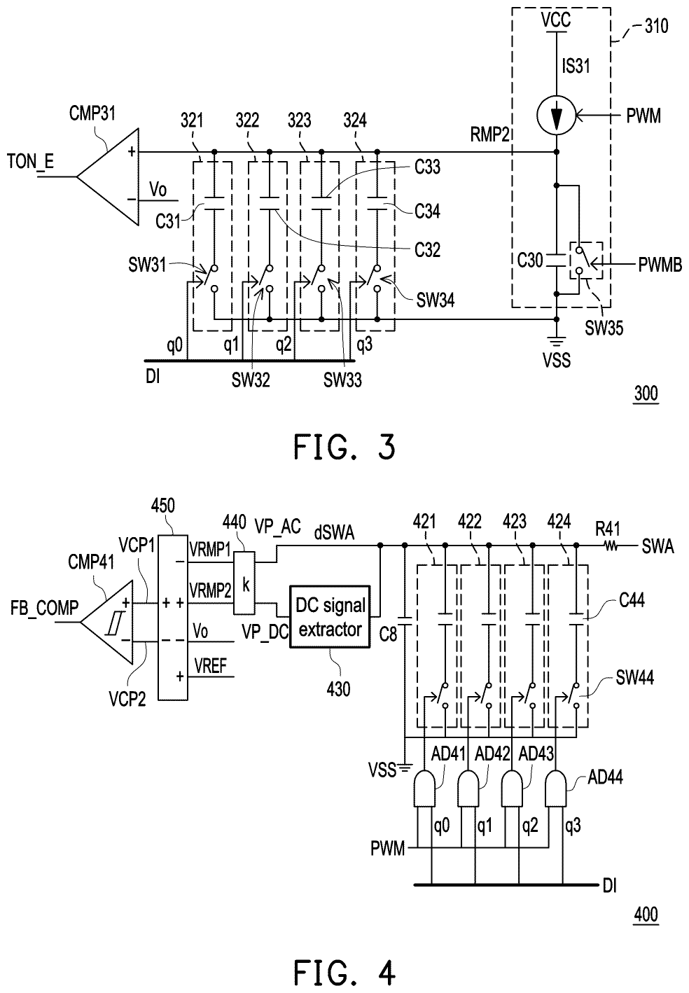

Refer to FIG. 3, FIG. 3 shows a circuit schematic diagram of a turned-on time adjuster of a power supply conversion device according to an embodiment of the disclosure. A turned-on time adjuster 300 includes a slope signal generator 310, delay units 321 to 324, and a comparator CMP31. The slope signal generator 310 includes a current source IS31, a capacitor C30, and a switch SW35. The capacitor C30 is connected in parallel with the switch SW35. The current source IS31 is connected in series with the parallel-connected capacitor C30 and switch SW35 between the power supply voltage terminal VCC and the reference ground terminal VSS. The current source IS31 of the slope signal generator 310 receives a control signal PWM, and provides a current to the capacitor C30 when the control signal PWM is in the turned-on state. The switch SW35 receives an inverted control signal PWMB, is cut off when the control signal PWM is in the turned-on state, and is turned on when the control signal PWM is in the turned-off state to discharge the capacitor C30.

The delay units 321 to 324 are coupled in parallel between an output terminal of the slope signal generator 310 and the reference ground terminal VSS. The output terminal of the slope signal generator 310 is a coupling point between the current source IS31 and the capacitor C30. The output terminal of the slope signal generator 310 is also coupled to a positive input terminal of the comparator CMP31. The delay units 321 to 324 respectively include capacitors C31 to C34 and switches SW31 to SW34. The capacitors C31 to C34 are respectively coupled in series with corresponding switches SW31 to SW34. The switches SW31 to SW34 are respectively controlled by the bits q0 to q3 of the detection information DI. When each of the switches SW31 to SW34 is turned on, the delay units 321 to 324 may provide a resistor-capacitor delay at the positive input terminal of the comparator CMP31, and may delay a rising slope rate of a slope signal RMP2 generated by the slope signal generator 310.

A negative input terminal of the comparator CMP31 receives the output voltage Vo, and generates the turned-on time termination signal TON_E by comparing the slope signal RMP2 and the output voltage Vo. The turned-on time termination signal TON_E is configured to indicate the termination time point when the control signal PWM is in the turned-on state.

Similarly, in this embodiment, the number of delay units 321 to 324 may be correspondingly adjusted according to the number of bits of the detection information DI to be generated. In addition, capacitance values of the capacitors C31 to C34 of the delay units 321 to 324 may be in a geometric sequence. For example, a ratio of the capacitance values of the capacitors C31 to C34 may be 8:4:2:1. A capacitance value of the capacitor C30 may be twice the capacitance value of the capacitor C31.

Refer to FIG. 4, FIG. 4 shows a circuit schematic diagram of a slope signal adjuster of a power supply conversion device according to an embodiment of the disclosure. A slope signal adjuster 400 includes delay units 421 to 424, AND gates AD41 to AD44, a DC signal extractor 430, a signal amplifier 440, an adder 450, and a comparator CMP41. An input terminal of the slope signal adjuster 400 is coupled to a switching terminal of the voltage converter, and receives the switching signal SWA through a resistor R41. The delay units 421 to 424 are coupled in parallel with each other, with one end of each of the delay units 421 to 424 receiving the switching signal SWA, and another end coupled to the reference ground terminal VSS.

The delay units 421 to 424 are respectively coupled to output terminals of the AND gates AD41 to AD44. One input terminal of each of the AND gates AD41 to AD44 receives the control signal PWM, and another input terminal of each of the AND gates AD41 to AD44 respectively receives the bits q0 to q3 of the detection information DI.

Each of the delay units 421 to 424 includes a capacitor and a switch. Taking the delay unit 424 as an example, a capacitor C44 of the delay unit 424 is coupled in series with a switch SW44. The switch SW44 is controlled by the output terminal of the corresponding AND gate AD44.

The delay units 421 to 424 respectively provide a delay value according to the bits q0 to q3 of the detection information DI, and generate a delay switching signal dSWA through the delay switching signal SWA. The delay switching signal dSWA may be provided to the DC signal extractor 430. The DC signal extractor 430 is configured to extract a DC component VP_DC of the delay switching signal dSWA. The signal amplifier 440 receives the DC component VP_DC and AC component VP_AC of the delay switching signal dSWA, and amplifies the DC component VP_DC and the AC component VP_AC (with a gain value of k), to generate a slope voltage VRMP1 and a slope voltage VRMP2 respectively. In addition, a capacitor C8 is coupled in parallel with each of the delay units 421 to 424, and is configured to provide a basic delay.

An adder 450 has multiple positive input terminals and multiple negative input terminals. The adder 450 adds the voltages (the slope voltage VRMP2 and a reference voltage VREF) received from the positive input terminal to generate a comparison voltage VCP1 at the positive output terminal. The adder 450 adds the voltages (the slope voltage VRMP1 and the output voltage Vo) received from the negative input terminal, and generates a comparison voltage VCP2 at the negative output terminal.

A positive input terminal of the comparator CMP41 receives the comparison voltage VCP1, and receives the comparison voltage VCP2 from the negative input terminal. By comparing the comparison voltage VCP1 with the comparison voltage VCP2, an output terminal of the comparator CMP41 may generate a feedback signal FB_COMP, and provide the feedback signal FB_COMP to the voltage converter. In this embodiment, the comparator CMP41 may be a hysteresis comparator.

Notably, in this embodiment, when the time length of the control signal PWM being in the turned-on state is extended, the slope signal adjuster 400 may increase the time delay provided by the delay units 421 to 424 to delay the switching signal SWA, in order to reduce a rising rate of the delay switching signal dSWA. Thereby, a voltage peak value of the delay switching signal dSWA may be substantially maintained at a fixed value without changing with the variation of the start time length of the control signal PWM, keeping the loop bandwidth unchanged.

Similarly, in this embodiment, the number of delay units 421 to 424 may be correspondingly adjusted according to the number of bits of the detection information DI to be generated.

In addition, the capacitance values of the capacitors of the delay units 421 to 424 may be in a geometric progression. For example, a ratio of the capacitance values of the capacitors of the delay units 421 to 424 may be 8:4:2:1.

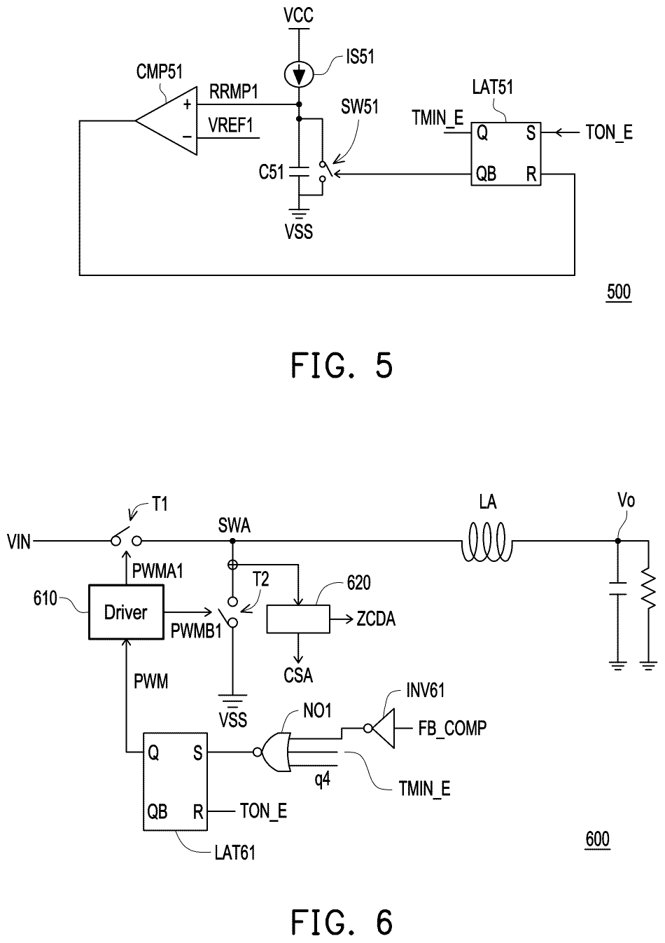

In the embodiment of the disclosure, a circuit 500 for a minimum turned-off time counter may further be provided to the power supply conversion device. Referring to FIG. 5, FIG. 5 shows a circuit schematic diagram of a minimum turned-off time counter of a power supply conversion device according to an embodiment of the disclosure. The circuit 500 for the minimum turned-off time counter is configured to compare the reference slope signal RRMP1 with a minimum turned-off time reference voltage VREF1, and generate a minimum turned-off time termination signal TMIN_E according to the comparison result. The circuit 500 for the minimum turned-off time counter includes a current source IS51, a switch SW51, a capacitor C51, a comparator CMP51, and a latch LAT51. The current source IS51, the switch SW51, and the capacitor C51 form a slope signal generator. The slope signal generator is configured to generate the reference slope signal RRMP1 according to the signal on an inverted output terminal QB of the latch LAT51. A voltage value of the reference slope signal RRMP1 is configured to reflect the time length of the signal in the turned-on state from the inverted output terminal QB of the latch LAT51. The comparator CMP51 compares the reference slope signal RRMP1 with the minimum turned-off time reference voltage VREF1, and is configured to determine whether the turned-off time of the control signal PWM is less than the minimum turned-off time. The comparator CMP51 generates an output signal according to the comparison result, and transmits the output signal to a reset terminal R of the latch LAT51 to reset the minimum turned-off time termination signal TMIN_E generated at the output terminal Q. Additionally, a set terminal S of the latch LAT51 receives the turned-on time termination signal TON_E.

The minimum turned-off time counter 500 transmits a minimum turned-off time terminate signal TMIN_E to the voltage converter, and makes the voltage converter to adjust the control signal PWM according to the minimum turned-off time terminate signal TMIN_E, so that the time length of the turned-off state of the control signal PWM is not less than the minimum turned-off time.

Referring to FIG. 6, FIG. 6 shows a circuit schematic diagram of a voltage converter of a power supply conversion device according to an embodiment of the disclosure. A voltage converter 600 includes power switches T1 and T2. First terminals of the power switches T1 and T2 are both coupled to an inductor LA. A second terminal of the power switch T1 receives an input voltage VIN. A second terminal of the power switch T2 is coupled to the reference ground terminal VSS. Control terminals of the power switches T1 and T2 are both coupled to a driver 610, and perform turn-on/turned-off switching by receiving driving signals provided by the driver 610, to generate a switching signal SWA at a node coupled with the inductor LA. The power switches T1 and T2 are alternately turned on and cut off under the control of the driving signals, to convert the input voltage VIN, and generate the output voltage Vo at an output terminal of the voltage converter 600 by the inductor LA which serves as an energy storage component. Here, the driver 610 receives the control signal PWM generated by the latch LAT61, and generates driving signals PWMA1, PWMB1 according to the control signal PWM to provide to the power switches T1 and T2 respectively.

In this embodiment, the voltage conversion circuit 600 further includes a current sensor 620. The current sensor 620 may be coupled to the first terminal of the power switch T2, configured to detect the current on the power switch T2, and generate current information CSA. Furthermore, the current sensor 620 may obtain a zero-crossing detection state ZCDA at the first terminal of the power switch T2 according to the current information CSA.

It is worth noting that a set terminal S of the latch LAT61 is coupled to an output terminal of a nor gate NO1. The three input terminals of the nor gate NO1 respectively receive an output signal of an inverter INV61, the minimum turned-off time termination signal TMIN_E as shown in the embodiment of FIG. 5, and the overshoot improvement signal q4 as shown in the embodiment of FIG. 2, where an input signal of the inverter INV61 is the feedback signal FB_COMP. The output signal of the nor gate NO1 is configured to set a logic value of the control signal PWM to 1 (entering the turned-on state). A reset terminal R of the latch LAT61 receives the turned-on time termination signal TON_E as shown in the embodiment of FIG. 3, and is configured to reset the logic value of the control signal PWM to 0 (entering the turned-off state).

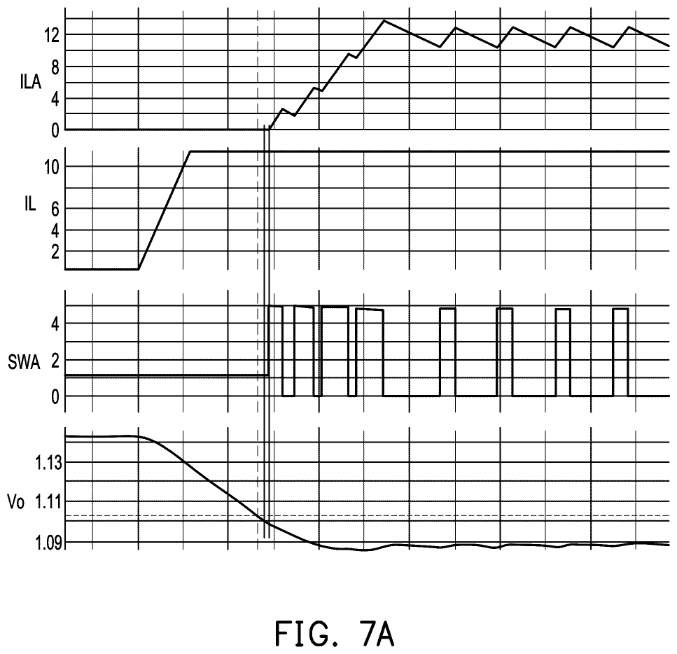

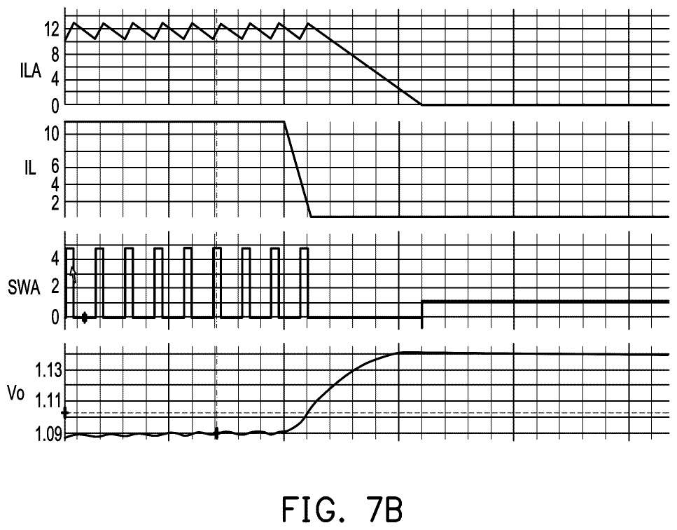

Referring to FIG. 7A and FIG. 7B, FIG. 7A and FIG. 7B respectively show timing diagrams of a power supply conversion device of an embodiment of the disclosure. In FIG. 7A and FIG. 7B, a horizontal axis is a time axis. Corresponding to the inductor current ILA (the current through the inductor LA shown in the embodiment of FIG. 6) and a load current IL, a vertical axis is a current value. Corresponding to the switching signal SWA and the output voltage Vo, the vertical axis is a voltage value. In FIG. 7A, the load of the power supply conversion device changes from light load to heavy load. Correspondingly, at the moment when the load current IL is increased, the power supply conversion device increases a width of a voltage pulse of the switching signal SWA by rapidly increasing the time length of the turned-on time of the control signal, thereby increasing the inductor current ILA. Under such condition, the power supply conversion device of this embodiment may rapidly increase the inductor current ILA to a high point with only four pulses of the switching signal SWA, to respond to the rise of the load current, and reduce the undershoot of the output voltage Vo.

In addition, in the steady state state, the width of the voltage pulse of the switching signal SWA may be restored to a normal value.

In FIG. 7B, the load of the power supply conversion device is converted from heavy load to light load. Correspondingly, at the moment when the load current IL is pulled down, the power supply conversion device turns off the voltage pulse of the switching signal SWA by quickly closing the turned-on time of the control signal, thereby reducing the inductor current ILA. Under such condition, the switching signal SWA of the power supply conversion device in this embodiment may not have redundant pulses after being turned off, thus avoiding additional overshoot.

Finally, it should be noted that: the aforementioned embodiments are only used to explain the technical solution of the disclosure, and not to limit thereto. Although the disclosure has been described in detail with reference to the foregoing embodiments, those skilled in the art should understand that they may still modify the technical solutions recorded in the foregoing embodiments, or make equivalent substitutions for some or all of the technical features. These modifications or substitutions do not make the essence of the corresponding technical solutions deviate from the scope of the technical solutions of the embodiments of the disclosure.

What is claimed is:

1. A power supply conversion device, comprising:
a voltage converter, receiving an input voltage, and converting the input voltage according to a control signal to generate an output voltage;
a turned-off time detector, coupled to the voltage converter, and detecting a time length of the control signal in a turned-off state to generate detection information;
a turned-on time adjuster, coupled to the turned-off time detector and the voltage converter, and adjusting a time length of the control signal in a turned-on state according to the detection information; and
a slope signal adjuster, coupled to the turned-off time detector and the voltage converter, adjusting a rising rate of a switching signal on a switching switch of the voltage converter according to the detection information to generate a slope signal, generating a feedback signal according to the slope signal, and providing the feedback signal to the voltage converter.

2. The power supply conversion device according to claim 1, wherein when the detection information indicates that the time length of the control signal in the turned-off state is falling, the turned-on time adjuster increases the time length of the control signal in the turned-on state according to the detection information, and when the detection information indicates that the time length of the control signal in the turned-off state is rising, the turned-on time adjuster decreases the time length of the control signal in the turned-on state according to the detection information.

3. The power supply conversion device according to claim 1, wherein the slope signal adjuster adjusts a rising rate of the slope signal according to the detection information to maintain a peak value of the slope signal at a fixed value.

4. The power supply conversion device according to claim 1, wherein the turned-off time detector comprises:
a first slope signal generator, generating a first slope signal based on turned-off time of the control signal;
a plurality of first comparators, comparing the first slope signal with a plurality of different first reference voltages respectively to generate a plurality of first comparison results;
a plurality of flip-flops, coupled to the plurality of first comparators, and latching the plurality of first comparison results to generate a plurality of bits of the detection information;
a second comparator and a third comparator, wherein the second comparator compares the first slope signal with a second reference voltage to generate a second comparison result, and the third comparator compares the output voltage with a set voltage to generate a third comparison result; and
a logic circuit, performing a logical operation according to the second comparison result and the third comparison result to generate an overshoot improvement signal.

5. The power supply conversion device according to claim 4, wherein the turned-off time detector further comprising:
a plurality of AND gates, configured to perform an AND logical operation on the control signal and outputs of the plurality of flip-flops respectively to generate the plurality of bits of the detection information.

6. The power supply conversion device according to claim 4, wherein the turned-on time adjuster comprising:
a second slope signal generator, generating a second slope signal based on a turned-on time of the control signal;
a plurality of first delay units, receiving the second slope signal, delaying the second slope signal according to the plurality of bits of the detection information to generate a delayed slope signal; and
a fourth comparator, comparing the delayed slope signal with the output voltage to generate a turned-on time termination signal,
wherein the voltage converter adjusts the control signal to be a termination time point of a turned-on state according to the turned-on time termination signal.

7. The power supply conversion device according to claim 6, wherein each of the plurality of first delay units comprises:
a capacitor; and
a switch, coupled in series with the capacitor between an output of the second slope signal generator and a reference ground terminal, wherein the switches of the plurality of first delay units are respectively controlled by different bits of the detection information.

8. The power supply conversion device according to claim 7, wherein capacitance values of the capacitors of the plurality of first delay units are in a geometric sequence.

9. The power supply conversion device according to claim 4, wherein the slope signal adjuster comprising:
a plurality of second delay units, receiving the switching signal, and delaying the switching signal according to the plurality of bits of the detection information to generate a delay switching signal;
a DC signal extractor, extracting a DC component of the delay switching signal;
a signal amplifier, amplifying the DC component and an AC component of the delay switching signal according to a gain to generate a first slope voltage and a second slope voltage respectively;
an adder, generating a first comparison voltage and a second comparison voltage according to the first slope voltage, the second slope voltage, the output voltage, and a reference voltage; and
a fourth comparator, comparing the first comparison voltage and the second comparison voltage to generate the feedback signal.

10. The power supply conversion device according to claim 9, wherein each of the plurality of second delay units comprises:
a capacitor; and
a switch, coupled in series with the capacitor between the switching signal and a reference ground terminal.

11. The power supply conversion device according to claim 10, wherein capacitance values of the capacitors of the plurality of second delay units are in a geometric sequence.

12. The power supply conversion device according to claim 10, wherein the slope signal adjuster further comprising:
a plurality of AND gates, respectively coupled to the plurality of second delay units, wherein a first input terminal of each of the plurality of AND gates receives the control signal, a second input terminal of each of the plurality of AND gates respectively receives each of the plurality of bits corresponding to the detection information, and an output terminal of each of the plurality of AND gates is respectively coupled to a control terminal of a switch corresponding to each of the plurality of second delay units.

13. The power supply conversion device according to claim 1, wherein the voltage converter sets the control signal to an enabled state according to the feedback signal.

14. The power supply conversion device according to claim 1, wherein the device further comprising:
a minimum turned-off time counter, comparing a reference slope signal with a minimum turned-off time reference voltage to generate a minimum turned-off time termination signal according to a comparison result,
wherein the voltage converter maintains the control signal in a turned-off state for a time length not less than a minimum set value according to the minimum turned-off time termination signal.
